(19) United States
(12) Patent Application Publication
(10) Pub. No.: US 2003/0005418 A1
(43) Pub. Date: Jan. 2, 2003

(54) Method for allocation, initialization and access of aggregate data types for architectures with differing memory granularity

(76) Inventors: C. Sridhar, Bangalore (IN); Shashi Bhushan Kumar, Bangalore (IN)

Correspondence Address: TEXAS INSTRUMENTS INCORPORATED, P O BOX 655474, M/S 3999, DALLAS, TX, 75265

(21) Appl. No.: 10/098,861

(22) Filed: Mar. 15, 2002

Related U.S. Application Data
(60) Provisional application No. 60/277,114, filed on Mar. 19, 2001.

(51) Int. Cl. G06F 9/45

(52) U.S. Cl. 717/140

(57) ABSTRACT

The present invention provides methods for facilitating the adaptation of shared data structures created in assembly language to differing memory models, compiler alignment constraints, and hardware alignment constraints. The use of these methods permits the assembler to create shared data structures that are transparently adapted to memory alignment differences introduced by the differing memory models and alignment constraints.

This application is related to and claims priority under 35 USC §119 (e)(1) to Provisional Application Serial No. 60/277,114, (TI-32563) Portable Technique for Allocation, Initialization and Access of Aggregate Data Type for DSP Architecture With Mixed Memory Granularity filed on Mar. 19, 2001.

### FIELD OF THE INVENTION

This invention generally relates to embedded software applications, and more specifically to embedded software applications combining source code written in a high level language with source code written in assembly language.

### BACKGROUND OF THE INVENTION

Embedded applications are typically developed using a composition of high level language, e.g., the C programming language, and low level assembly language. The high level language provides abstraction and portability and is best suited to represent target independent modules of the application. Assembly language is used to develop low level, target dependent functionality, e.g., device drivers, and where optimal processor performance is desired. In such applications, it is common and desirable for the modules written in the high level language and the assembly language modules to share data structures.

The shared data structures may be allocated and optionally initialized by either the high level language compiler in response to specifications in the high level language source code or by the assembler in response to specifications in the assembly language source code. In the latter case, the data structures must be created to conform to compiler conventions for alignment of such structures in memory and the memory length of primitive data types. These compiler conventions are based on the memory models supported by the target hardware. For example, the TMS320C55 C compiler available from Texas Instruments Incorporated supports both a small and a large memory model, wherein the length of a data pointer is 16 bits in the small memory model and 23 bits in the large memory model.

Finally, the architecture of the target hardware of the application may impose memory alignment requirements. For example, the architecture may require that all code pointers be located at even word addresses, regardless of the actual length of the pointer. And, the architecture may provide support for both 16-bit data addresses and 23-bit data addresses where a 16-bit data address may be located at either an even or odd word address while a 23-bit data address must be located at an even word address.

Therefore, there are a variety of combinations or sets of memory alignment constraints attributable to differing memory models, compiler alignment constraints, and hardware alignment constraints that may be imposed on a data structure used by both high level language and assembly code. Current approaches to handling these combinatorial factors have significant development and maintenance costs when an embedded application is targeted for multiple architectures with differing memory models. Multiple possible sets of memory alignment constraints are possible in this situation. While the high level language modules can simply be recompiled with a compiler target to the desired memory model and hardware architecture, the shared data structures in the assemble language modules must be modified for each new set of memory alignment constraints introduced.

These modifications to support the new architectures will likely involve a significant re-write of the shared data structures. The programmer has to re-analyze the structures in view of the new memory alignment requirements and determine the appropriate alignment and offset of each element. Any changes to the data structures must be done manually by the programmer, creating a potential for the introduction of errors. Also, multiple versions of the data structures are created, posing future maintenance issues.

### SUMMARY OF THE INVENTION

The present invention provides methods for facilitating the adaptation of shared data structures created in assembly language to differing memory models, compiler alignment constraints, and hardware alignment constraints, across the same as well as different hardware architectures. The use of these methods permits the assembler to create shared data structures that are transparently adapted to memory alignment differences introduced by the differing memory models and alignment constraints.

Methods are provided for creating a data structure in assembly language that conforms to the semantics of an analogous data structure in a high level language wherein the method transparently adapts the data structure to a selected set of memory alignment constraints. One such method comprises defining a set of primitive data types that have a one-to-one correspondence to analogous primitive data types in the high level language such that the definition of each primitive data type is transparently adapted to the selected set of memory alignment constraints; defining a template for the data structure wherein each element of the data structure is either selected from the set of primitive data types or is a substructure that is transparently adapted to the selected set of memory alignment constraints and the data structure length is transparently adapted to the selected set of memory alignment constraints; allocating memory for the data structure based on the template definition such that the allocated memory transparently conforms to the selected set of memory alignment constraints; and creating an initialization record for the data structure that is transparently adapted to the selected set of memory alignment constraints.

### BRIEF DESCRIPTION OF THE DRAWINGS

Particular embodiments in accordance with the invention will now be described, by way of example only, and with reference to the accompanying drawings in which like reference signs are used to denote like parts unless otherwise stated, and in which:

FIG. 1 presents a flowgraph of a method for creating a data structure in assembly language that conforms to the semantics of an analogous data structure in a high level language such that the data structure is transparently adapted to a selected set of memory alignment constraints;

FIG. 2A is a flowgraph of one possible method for defining a template for the data structure of FIG. 1;

FIG. 2B is a flowgraph of an improved version of the method of FIG. 2A;

FIG. 3 is a logical representation of a pipe data structure specified in assembly language source code contained in Table 2 that illustrates a method for creating a data structure in assembly language that conforms to the semantics of an analogous data structure in a high level language such that the data structure is transparently adapted to a selected set of memory alignment constraints;

FIG. 4 is a flowgraph of a method for allocating memory for the data structure of FIG. 1 as defined by the template of FIG. 2A or FIG. 2B; and

FIG. 5 is a flowgraph illustrating a method for creating the initialization record for the data structure of FIG. 1.

Corresponding numerals and symbols in the different figures and tables refer to corresponding parts unless otherwise indicated.

### DETAILED DESCRIPTION OF EMBODIMENTS OF THE INVENTION

Methods for facilitating the adaptation of shared data structures created in assembly language to differing memory models, compiler alignment constraints, and hardware alignment constraints have now been developed by the present inventors. The use of these methods permits the assembler to create shared data structures that are transparently adapted to alignment differences introduced by the differing memory models and alignment constraints. These methods are described below assuming that the high level language used is C and that the target memory models are a small model with a 16-bit address space for data and a 24 bit address space for code and a large model with a 23-bit address space for data and a 24 bit address space for code. The architecture of the target processor requires that all code pointers and all data pointers larger than 16 bits be located on even word boundaries in memory. 16-bit data pointers may be located on even or odd word boundaries in memory. Adaptation of these methods to other high level languages, such as C++ or Java, other memory models, and/or other processor architectures is obvious to one skilled in the art.

The examples provided in the tables and figures assume that the target processor is a Texas Instruments Incorporated TMS320C55x with a corresponding assembler and C compiler. The assembly language for this processor's assembler is documented in the “TMX320C55x Assembly Language Tools User's Guide” available at http://www-s.ti.com/sc/psheets/spru280d/spru280d.pdf. The assembler directives used in the examples are explained in more detail in Appendix A. The C compiler for this processor is documented in the “TMX320C55x Optimizing C/C++ Compiler Users Guide” available at http://www-s.ti.com/sc/psheets/spru281c/spru281c.pdf.

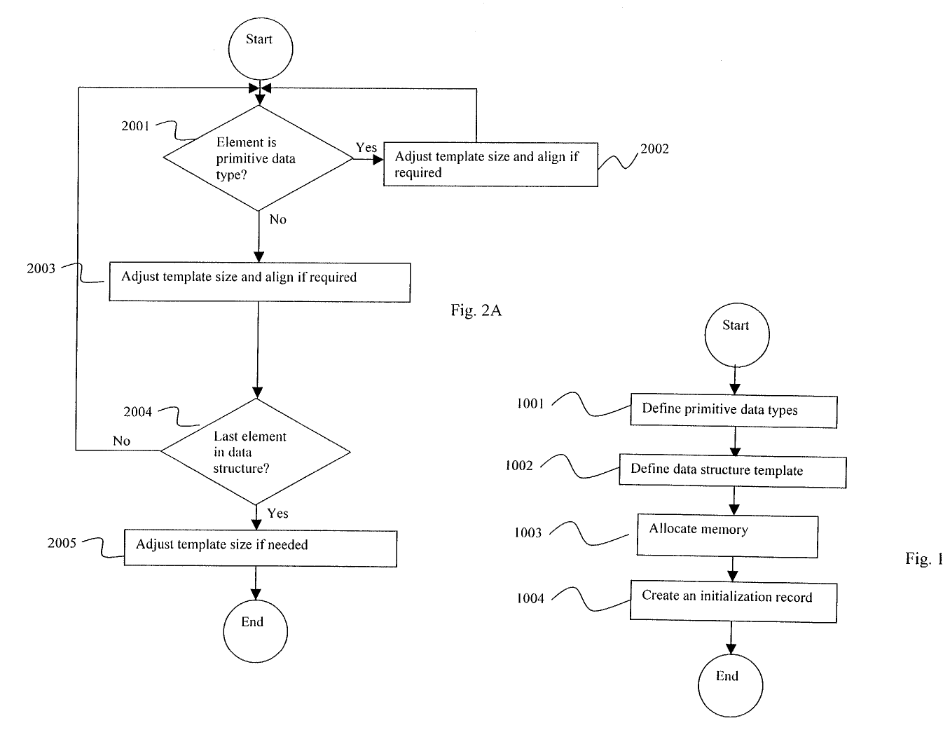

FIG. 1 presents a flowgraph of a method for creating a data structure in assembly language that conforms to the semantics of an analogous data structure in a high level language such that the data structure is transparently adapted to a selected set of memory alignment constraints. Creating the data structure entails defining the data structure, allocating space for it in memory, and initializing the contents of each element. As the data structure is created, adjustments are made as needed to the overall length of the structure and to the alignment of the data structure and its elements to conform to the selected set of memory alignment constraints. In addition, the initialization record for the data structure is adapted to allow for these adjustments. This transparent adaptation occurs without requiring any changes in the source code defining the data structure.

The TMS320C55x C compiler requires that any data structure that contains elements having alignment constraints must begin at an even memory address and be of even length. An element in a data structure has a memory alignment constraint if it must be placed at an even address or offset in memory but its relative location in the data structure would cause it to be placed at an odd address or offset due to the placement and length of previous elements. The TMS320C55x architecture mandates that 32 bit data be placed at an even address. In the small memory model, a code pointer is 32-bits and thus has an alignment constraint requiring it to be placed at an even address within a data structure while a data pointer is limited to 16-bits and has no alignment constraint. In the large memory model, both code pointers and data pointers have alignment constraints and must be placed at even addresses within a data structure. Any other data elements greater than 16-bits in length will also have alignment constraints in either memory model. Furthermore, if an element of a data structure is another data structure, generically referred to as a substructure, that substructure may also have an alignment constraint due to its element composition.

In step 1001, a set of primitive data types having a one-to-one correspondence to analogous primitive data types in the high level language is defined. The definition of each primitive data type is transparently adapted to the selected set of memory alignment constraints. The C programming language includes several primitive data types but for illustration purposes, only the primitive data types for an integer, a code pointer, and a data pointer will be considered. An integer, which has the mnemonic Int, is a single memory word in length. A code pointer, which has the mnemonic CodePtr, is a long word in length. In the small memory model, a data pointer, which has the mnemonic DataPtr, is a single memory word in length. In the large memory model, a DataPtr is a long word in length.

In the embodiment presented in Table 1, the transparent adaptation of these primitive data types to the selected memory model is illustrated in lines 8-34. If the large memory model is selected when the source code is assembled, a DataPtr is defined to be a long memory word. Otherwise, it will be defined to be a single memory word. A CodePtr is defined to be a long memory word and an Int is defined to be a single memory word as the specified memory model does not affect their length. The .long assembler directive, as used in lines 9, 10, and 23, causes its 32-bit value to be placed at an even memory address. The .word assembler directive, as used in line 22 to define a DataPtr in the small memory model, causes its 16-bit value to be placed at the next consecutive memory location as there is no alignment constraint for such a value. As a result of this definition process, the use of the mnemonics elsewhere in the assembly language source code to define elements of a data structure will cause a corresponding amount of memory space to be reserved for the element and that any corresponding alignment constraint be enforced.

In step 1002, a template for the data structure is defined. Each element of the data structure is defined to be either a primitive data type or a substructure. If an element is a substructure, its memory alignment is transparently adapted as necessitated by the selected set of memory alignment constraints. The length of the data structure is also transparently adapted to conform to the selected set of memory alignment constraints.

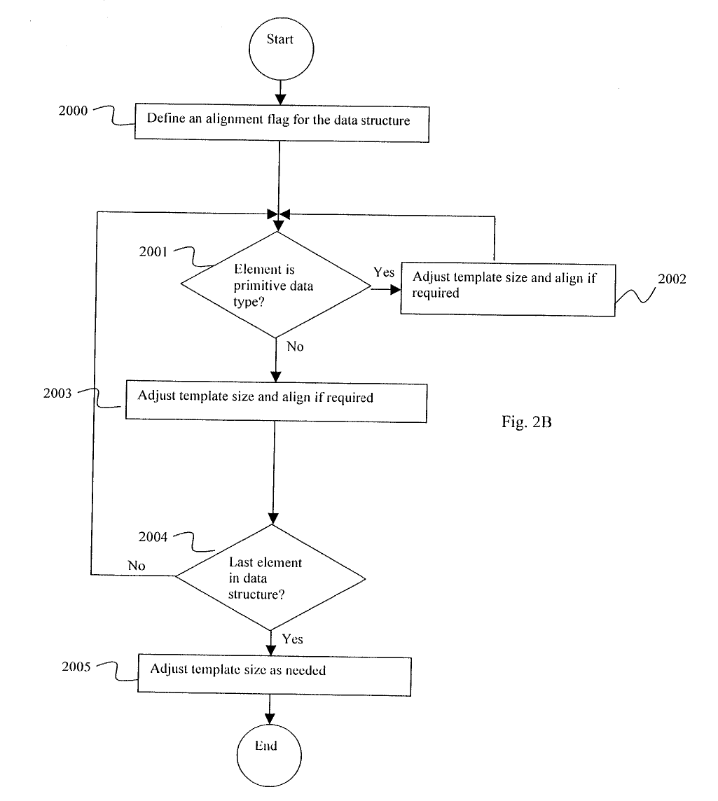

FIG. 2A is a flowgraph of one possible method for defining a template for the data structure. The type of an element is determined at step 2001. If it is a primitive data type, at step 2002 the assembler increases the length of the template by the length of the primitive data type, and places the element within the data structure as required by its alignment constraint. If the element is not a primitive data type, then it is a substructure. In step 2003, the length of the template is increased to include the length of the substructure and the substructure is started at an even offset if it has an alignment constraint. If placing the substructure at an aligned boundary creates padding in the data structure, the length of the template is also increased to accommodate the space for that padding. As indicated by step 2004, the definition of the template continues until each element has been considered. At step 2005, if the data structure itself had an alignment constraint, the length of the template is increased to include any padding required at the end of the data structure to make its overall length even.

FIG. 2B is a flowgraph of an improved version of the method of FIG. 2A. In this method, step 2000 is added to define an alignment flag for the data structure. This flag is uniquely associated with the data structure and is given a value to indicate whether or not the data structure has an alignment constraint. Substructures will always have such an alignment flag as they are also data structures. In the steps that consider whether the data structure or a substructure has an alignment constraint, the appropriate alignment flag is checked to make a determination.

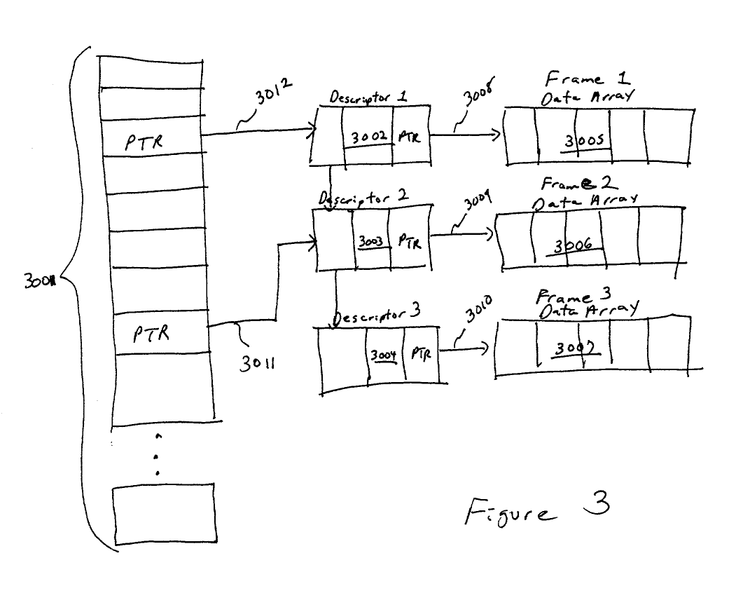

Table 2 contains assembly language source code illustrating the use of an embodiment of the invention. This source code uses the constructs and macros of the embodiment contained in Table 1 to specify the creation of a pipe data structure. FIG. 3 is a logical representation of the pipe data structure created by this source code. As this figure illustrates, the pipe data structure is composed of main data structure 3001 and several substructures 3002-3007 that are linked to main data structure 3001 by pointers 3011-3012. The source code in Table 2 specifies the entire data structure using an embodiment of the invention. A discussion of the portion of the source code specifying the main data structure 3001 is sufficient to allow one skilled in the art to determine how the method is used to create additional substructures 3002-3007.

The template for main data structure 3001, named PIP_Obj, is defined at lines 66-73 of Table 2. Its corresponding alignment flag, isPipAligned, is defined at line 36. The PIP_Obj template is defined by the use of two assembler directives, .struct and .endstruct. The .struct directive assigns offsets to the elements of the data structure. It does not allocate memory; it merely creates a symbolic template that can be used repeatedly. Following the .struct directive, each element of the template is defined using the primitive data types defined in lines 8-34 of Table 1 or other appropriate assembler directives. At line 67, the first element of the template is declared to be an integer using the Int primitive data type. This element is placed at offset 0 within the data structure. The assembler increases the length of structure by 1 as dictated by the length of the element. The next element will begin at an offset of 1. The second element of the template is defined at line 69. This element is actually a substructure and is defined using the .tag assembler directive. The .tag directive essentially causes the template definition of the designated substructure to be inserted in the PIP_Obj template at this point. The designated substructure, PIP_Sock, is defined at lines 47-60 in Table 2.

Because PIP_Sock is a substructure and it has an alignment constraint per its alignment flag defined at line 35, it must always be placed at an even offset. To ensure that this constraint is honored, its use in the parent structure is preceded by a pad definition at line 68 that will be conditionally applied. The pad is defined using the .align assembler directive. The .align directive forces an alignment of the element to the next memory boundary as specified by the value of the parameter. A hole is created if the current alignment is not on the correct boundary. In this instance, the parameter for the .align directive is the alignment flag, isPipsockAligned, defined at line 35. Because the value of this alignment flag is 2, the .align directive will force the definition of the PIP_Sock substructure to start at an even offset. As the current offset within the structure is 1, the align construct creates a hole of length 1 and places the substructure at offset 2.

The third element of the template is defined at line 71. This element is also a PIP_Sock substructure and is preceded by a conditional pad at line 70. Because the second element was a substructure, its template definition forced it to be of even length. Therefore, because it was placed an even offset within the data structure, the third element will automatically be placed an even offset. The conditional pad at line 70 will not introduce a hole in the data structure.

As all elements of the template have now been specified, the template is terminated at line 60 with an .endstruct directive. Because all data structures that have alignment constraints must have an even length, another conditional pad is inserted at line 59. If the current offset is odd, this directive will create a hole and make the current offset even. Since this is the end of the template, the current offset would be the length of the structure. In this particular instance, the directive will have no effect as the ending location of the template is on an even offset.

Referring back to FIG. 1, at step 1003 memory is allocated for the data structure. This allocation is derived from the template defined for the data structure and is transparently adapted to the selected set of memory constraints.

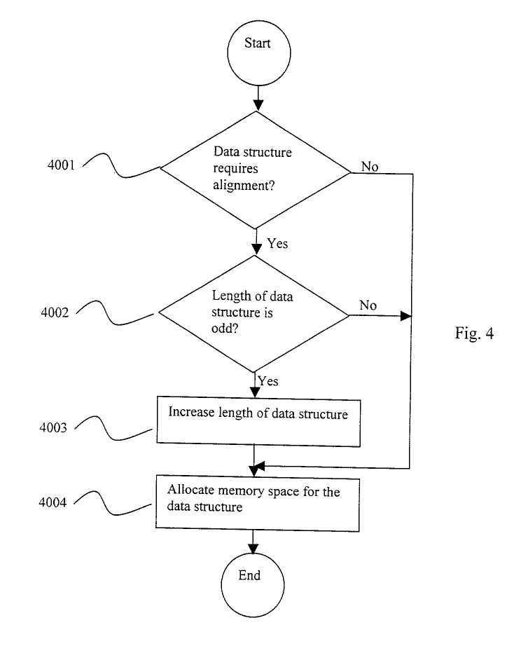

FIG. 4 is a flowgraph of a method for allocating memory for the data structure as defined by the template of the data structure. At step 4001, a determination is made as to whether the data structure has alignment constraints. If it does not, the ensuing steps are skipped and step 4004 is executed. If it does have alignment constraints, a check is made at step 4002 to determine if the overall length of the data structure is odd. If it is, the length is increased to the next even number at step 4003. Otherwise, step 4003 is skipped. At step 4004, the required amount of memory space for the data structure is allocated.

An embodiment of an allocation method is presented in the assembly language source code in Table 1. Lines 289-351 contain the definition of a memory allocation macro, C55_allocateObject. This macro takes as its parameters, among other things, the alignment flag for the data structure, the symbolic name to be given to this instance of the data structure, and the length of the data structure. This macro allocates the required amount of memory and returns the address where the memory is allocated as the value of the symbolic name. At line 313, the alignment flag is checked. If the alignment flag value indicates that the data structure to be allocated must be aligned, then the overall length of the data structure must be an even number, and it must be located at even address. At lines 314-316, the length of the data structure is increased to an even length if necessary. At line 318, the memory for the data structure is actually allocated. This allocation is accomplished by the .usect assembler directive. This directive reserves the requested amount of memory space and, if required, forces the initial address of the reserved space to occur at an aligned memory location. The alignment flag for the data structure is given to this directive as a parameter to be used to make the alignment determination.

Lines 137-293 of Table 2 present the source code for a macro that is used to create an instance of the previously discussed PIP_Obj. At line 182, the macro C55_allocateObject is called to allocate the required memory space. Note that PIP_SIZE is defined to be the length of the PIP_Obj template at line 128.

Referring back to FIG. 1, at step 1004 an initialization record is created for the data structure. This initialization record contains the values that are to be inserted in the initial version of the data structure created when the application is executed. This initialization record will typically be created in an initialization memory that is accessed when execution begins. The length and contents of the record are transparently adapted as required to conform to the selected set of memory constraints as it is created. This transparent adaptation comprises ensuring that all values in the initialization record are aligned in the same manner as the elements in the data structure to be initialized by the record. In addition, any holes in the data structure created as a result of matching the alignment constraints may be filled with a predetermined value.

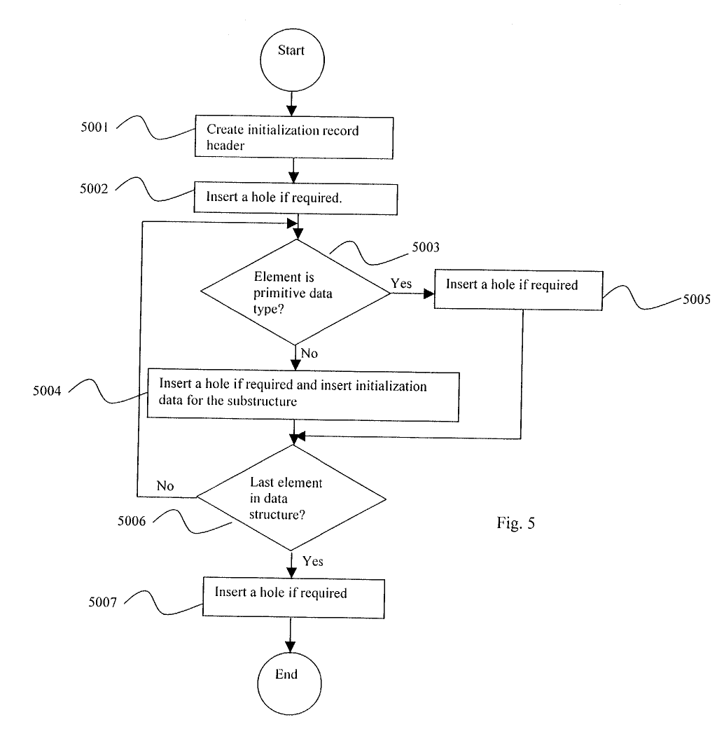

FIG. 5 is a flowgraph illustrating a method for creating the initialization record for a data structure such that the length and contents of the record are transparently adapted as required to conform to the selected set of memory constraints. At step 5001, a header for the initialization record is created. This header will typically contain information about the length and the address of the data structure. At step 5002, a hole is inserted following the header if required to make the first value in the initialization record occur at a memory alignment conforming to the selected set of memory alignment constraints. The, the value for each element of the data structure is stored in the initialization record. As exemplified by step 5003, if the next element of the data structure is a primitive data type, at step 5005 its value is inserted in the initialization record at the memory alignment required by the selected set of memory alignment constraints and a hole is created if required. If the next element is a substructure, the value of its first element must be placed in the initialization record in accordance with any alignment constraints indicated by the alignment flag of the substructure. If necessary, a hole in the initialization record is created to permit the correct alignment. The values of the substructure elements are then recorded in the initialization record in the same manner as for the parent data structure. That is, steps 5003 through 5007 are performed for the substructure elements. This process of inserting values in the initialization continues until the value for the last element of the data structure has been recorded, as shown at step 5006. Finally, at step 5007, a final hole is inserted if required to make the length of the initialization record even. This requirement will be determined from the alignment constraints indicated by the alignment flag associated with the data structure.

An embodiment of the method of FIG. 5 is presented in the assembly language source code in Table 1 and Table 2. First, in Table 1, are macros used to create an initialization record. The macro C55_cinitHeader at lines 40-80 is called to create a header record containing length of the data structure and its memory address. This macro also initializes a variable representing the current offset of an element value within the initialization record at line 79. This variable will be incremented by all subsequent macros used in the process of inserting values in the initialization record. The macros C55_cinitBegin, at lines 114-136, and C55_cinitEnd, at lines 138-159, are called at the beginning and the end, respectively, of the insertion of the initialization values into the initialization record for the data structure and for any substructures within that data structure. The C55_cinitBegin macro calls the C55_alignIfRequired macro at line 135. This macro, defined at lines 82-111, checks the alignment flag associated with the data structure at line 102. If alignment at an even memory address is required, then the current element value offset within the initialization record is checked. If this offset is odd, a predetermined value is inserted into the initialization record to fill the hole that is created by this alignment constraint and the offset is incremented to the next even boundary. The C55_cinitEnd macro takes the alignment flag of the data structure as an argument. If the value of the alignment flag indicates that the data structure must be of even length, the macro checks the value of the offset. If the offset is odd, a hole is created at the end of the initialization record to make its length even and a predetermined value is placed in that hole.

The macros that create the initialization values for each of the primitive data types are at lines 161-287. Each takes as its argument the value to be inserted in the initialization record and each macro detects if a hole is created by the alignment constraints of the primitive data type, places a predetermined value in that hole and place n initialization value for primitive data type in the initialization record. Each macro increases the offset variable by the length of the primitive type and length of the hole, if created.

The use of these macros to create an initialization record is illustrated in Table 2. At line 190, C55_cinitHeader is called to create the header record for a PIP_Obj data structure. At line 216, C55_cinitBegin is called to indicate the beginning of the value portion of the initialization record. This macro, as indicated above, will cause an alignment adjustment if required by the memory alignment constraints indicated by the PIP_OBJ alignment flag by creating a hole and filling it with a predetermined value. At this point, the offset is zero so there is no need to change the memory alignment. At line 22, the value for the first element of the PIP_Obj data structure is inserted in the initialization record. This element is an Int primitive data type so the corresponding macro, C55_cinitInt, is called to insert the integer value in the initialization record. This macro would also increase the offset variable to 1. The next two elements of the data structure are PIP_Sock substructures. In this embodiment, each substructure provides its own macro for inserting its values into the initialization record of the parent data structure. The initialization macro for the PIP_Sock substructure, PIPSOCK_cinitObj is located at lines 235-349. Note that this macro uses the initialization macros provided in Table 1. The memory alignment constraints indicated by the associated alignment flag isPipSockAligned will be followed as this portion of the initialization record is created. This macro is called at lines 224 and 231 in Table 2 to insert the initialization values for the two substructures. Finally, at line 233, c55_cinitEnd is called to complete the initialization record for PIP_Obj.

While the invention has been described with reference to illustrative embodiments, this description is not intended to be construed in a limiting sense. Various other embodiments of the invention will be apparent to persons skilled in the art upon reference to this description. It is therefore contemplated that the appended claims will cover any such modifications of the embodiments as fall within the true scope and spirit of the invention.

TABLE 1

| | |
|---|---|
| 1 | ; ======== cinit.h55======== |
| 2 | ; |

| | |
|---|---|
| 4 | .if($isdefed(“CTNIT_”) = 0) ; prevent multiple includes of this file |

| | |
|---|---|
| 5 | CINIT_ .set 1 |
| 6 | .include “chk.h55” |
| 7 | ; Define DataPtr, CodePtr, Int |

| | |
|---|---|
| 8 | .if($isdefed(“_large_model”)) |

| | |
|---|---|
| 9 | .asg .long, DataPtr |
| 10 | .asg .long, CodePtr |
| 11 | .asg .word, Int |
| 12 | .asg .long, Long |
| 13 | .asg DataPtr, Arg |
| 14 | .asg DataPtr, Args |
| 15 | .eval 2, DATAPTRSIZE |
| 16 | .eval 1, INTSIZE |
| 17 | .eval 2, CODEPTRSIZE |
| 18 | .eval 2, ARGSIZE |
| 19 | .asg 2, isDataPtrAligned |
| 20 | .asg 1, isIntAligned |

| | |
|---|---|
| 21 | .else |

| | |
|---|---|
| 22 | .asg .word, DataPtr |
| 23 | .asg .long, CodePtr |
| 24 | .asg .word, Int |
| 25 | .asg .long, Long |
| 26 | .asg DataPtr, Arg |
| 27 | .asg DataPtr, Args |
| 28 | .eval 1, DATAPTRSIZE |
| 29 | .eval 1, INTSIZE |
| 30 | .eval 2, CODEPTRSIZE |
| 31 | .eval 1, ARGSIZE |
| 32 | .asg 1, isDataPtrAligned |
| 33 | .asg 1, isIntAligned |

| | |
|---|---|
| 34 | endif |
| 35 | |

| | | | |
|---|---|---|---|
| 36 | DATAPAGE | .set | 0 |

| | | | |
|---|---|---|---|
| 37 | CINITALIGN | .set | 1 |
| 38 | | | |
| 39 | | | |

| 40 | ;# ======== C55_cinitHeader======== | |
|---|---|---|
| 41 | ; Create the header section of cinit records. | |
| 42 | | |
| 43 | ; Parameters | |
| 44 | ; cinitAlign: | Alignment constraints for cinit record |
| 45 | ; isObjAligned: Alignment constraint for the object. This indicates | |
| 46 | ; | if objects members or any of its sub objects have |
| 47 | ; | members that have alignment constraints. |

| | | |
|---|---|---|
| 48 | ; objAddr: | Is the addr of the object |
| 49 | ; objSize: | It is the size of the object |

| | |
|---|---|
| 50 | ; page: Is the page where the object exists. |
| 51 | ;# |
| 52 | ;# Preconditions: |
| 53 | ;# none |
| 54 | ;# |
| 55 | ;# Postconditions: |
| 56 | ;# offset = 0 |
| 57 | ;# |
| 58 | ;# Constraints and Calling Environment: |
| 59 | ;# The macro must be called for creating cinit records only. |
| 60 | |

| | |
|---|---|
| 61 | .asg “:C55_cinitHeader$regs”, C55_cinitHeader$regs |
| 62 | |

| | |
|---|---|
| 63 | C55_cinitHeader .macro cinitAlign, isObjAligned, objAddr, objSize, page |

| | |
|---|---|
| 64 | CHK_nargs “CINIT”, page |
| 65 | .eval :objSize:, cinitSize ; This is the size of |

| | |
|---|---|
| 66 | ; cinit records. |

| | | |
|---|---|---|
| 67 | if (isObjAligned = 2) ; | Does the Obj require alignment |

| | | |
|---|---|---|
| 68 | .if(:objSize: & 0×1) | ; if the cinit size is odd |

| | |
|---|---|
| 69 | .eval cinitSize + 1, cinitSize ; Make it even |

| | |
|---|---|
| 70 | .endif |

| 72 | .endif | |
|---|---|---|
| 73 | | |
| 74 | .align cinitAlign | ; Create the cinit header |
| 75 | .sect “.cinit” | |
| 76 | .field cinitSize | ; size |

| | | |
|---|---|---|
| 77 | .field objAddr, 24 | ; address |
| 78 | .field page, 8 | ; page |

| | | |
|---|---|---|
| 79 | .eval 0, offset | ; initialize the offset to 0 |

| 80 | .endm | |
|---|---|---|
| 81 | | |
| 82 | ;# ======== C55_alignIfRequire ======== | |
| 83 | ; This macro checks if the offset is odd, and creates a hole | |
| 84 | ; with a value of dead. | |
| 85 | | |
| 86 | ; Parameters | |
| 87 | ; isObjAligned: Alignment constraint for the object. This indicates | |
| 88 | ; | if objects members or any of its sub objects have |
| 89 | ; | members that have alignment constraints. |

| 90 | ;# | |
|---|---|---|
| 91 | ;# Preconditions: | |
| 92 | ;# none | |
| 93 | ;# | |
| 94 | ;# Postconditions: | |
| 95 | ;# | |
| 96 | ;# | |
| 97 | ;# Constraints and Calling Environment: | |
| 98 | ;# The macro must be called for creating cinit records only. | |
| 99 | C55_alignIfRequired .macro | isObjAligned |

| 100 | CHK_nargs “CINIT”, isObjAligned | |
|---|---|---|
| 101 | | |
| 102 | .if(isObjAligned = 2) | : Does the obj requir |

| | |
|---|---|
| 103 | ; alignment |

| | | |
|---|---|---|
| 104 | .if(offset & 0×1) | ; if the object is at |

| | |
|---|---|
| 105 | ; odd offset |

| | | |
|---|---|---|
| 106 | .word 0×dead | ; create a dead word |

| | |
|---|---|
| 107 | .eval offset + 1, offset |

| | |
|---|---|
| 108 | ; increase the offset |

| | |
|---|---|
| 109 | .endif |

| | |
|---|---|
| 110 | .endif |

| 111 | .endm | |
|---|---|---|
| 112 | | |
| 113 | | |
| 114 | ;# ======== C55_cinitBegin ======== | |
| 115 | ; This macro checks if the offset is odd, and creates a hole | |
| 116 | ; with a value of dead. | |
| 117 | | |
| 118 | ; Parameters | |
| 119 | ; isObjAligned: Alignment constraint for the object. This indicates | |
| 120 | ; | if object's members or any of its sub-objects have |
| 121 | ; | members that have alignment constraints. |

| | |
|---|---|
| 122 | ;# |
| 123 | ;# Preconditions: |
| 124 | ;# none |
| 125 | ;# |
| 126 | ;# Postconditions: |
| 127 | ;# |
| 128 | ;# |
| 129 | ;# Constraints and Calling Environment: |
| 130 | ;# The macro must be called before initializing any value field |
| 131 | ;# of a cinit record. |
| 132 | |
| 133 | C55_cinitBegin .macro isObjAligned |

| | |
|---|---|
| 134 | CHK_nargs “CINIT”, isObjAligned |
| 135 | C55_alignIfRequired isObjAligned |

| 136 | .endm | |
|---|---|---|
| 137 | | |
| 138 | ;# ======== C55_cinitEnd ======== | |
| 139 | ; This macro checks if the offset is odd, and creates a hole | |
| 140 | ; with a value of dead. | |
| 141 | | |
| 142 | ; Parameters | |
| 143 | ; isObjAligned: Alignment constraint for the object. This indicates | |
| 144 | ; | if object's members or any of its sub-objects have |
| 145 | ; | members that have alignment constraints. |

| | |
|---|---|
| 146 | ;# |
| 147 | ;# Preconditions: |
| 148 | ;# none |
| 149 | ;# |
| 150 | ;# Postconditions: |
| 151 | ;# |
| 152 | ;# |
| 153 | ;# Constraints and Calling Environment: |
| 154 | ;# The macro must be called at the end of ciniting a structure |
| 155 | |
| 156 | C55_cinitEnd .macro isObjAligned |

| | |
|---|---|
| 157 | CHK_nargs “CINIT”, isObjAligned |
| 158 | C55_alignIfRequired isObjAligned |

| | |
|---|---|
| 159 | .endm |
| 160 | |
| 161 | ;# ======== C55_cinitDataPtr ======== |
| 162 | ; Initialize a data ptr in a cinit record. |
| 163 | |
| 164 | ; Parameters |
| 165 | ; value: value to which the record must be initialized |
| 166 | ;# |
| 167 | ;# Preconditions: |
| 168 | ;# none |
| 169 | ;# |
| 170 | ;# Postconditions: |
| 171 | ;# |
| 172 | ;# |
| 173 | |
| 174 | C55_cinitDataPtr .macro value |

| | |
|---|---|
| 175 | CHK_nargs “CINIT”, value |
| 176 | if ($isdefed(“_large_model”)) |

| | |
|---|---|
| 177 | ; compilaton |

| | |
|---|---|
| 178 | .if (offset & 0×1); if at odd offset |

| | |
|---|---|
| 179 | .word 0×dead ; fill in the hole |

| | |
|---|---|
| 180 | .eval offset + 1, offset |

| | |
|---|---|
| 181 | ; increase the offset |
| 182 | ; for hole filled. |

| | | |
|---|---|---|
| 183 | .endif | |
| 184 | .xlong value: | ; Fill in the value |
| 185 | eval offset + 2, offset | ; Increase the offset |
| 186 | | ; corresponding size |
| 187 | | ; of dataPtr. |

| | |
|---|---|
| 188 | .else |

| | | |
|---|---|---|
| 189 | .word :value: | : If in near mode just |

| | |
|---|---|
| 190 | ; fill the value. |

| | | |
|---|---|---|
| 191 | .eval offset + 1, offset | ; increase the offset |

| | |
|---|---|
| 192 | ; coressponding to |
| 193 | ; that of data ptr. |

| | |
|---|---|
| 194 | .endif |
| 195 | .endm |
| 196 | |
| 197 | ;# ========C55_cinitCodePtr ======== |
| 198 | ; Initialize a code ptr in a cinit record. |
| 199 | |
| 200 | ; Parameters |
| 201 | ; value: value to which the record must be initialized |
| 202 | ;# |
| 203 | ;# Preconditions: |
| 204 | ;# none |
| 205 | ;# |
| 206 | ;# Postconditions: |
| 207 | ;# |
| 208 | ;# |
| 209 | |
| 210 | C55_cinitCodePtr .macro value |

| | |
|---|---|
| 211 | CHK_nargs “CINIT”, value |
| 212 | .if (offset & 0×1); if at odd offset |

| | |
|---|---|
| 213 | word 0×dead ; fill in the hole |
| 214 | eval offset + 1, offset |

| | |
|---|---|
| 215 | ; increase the offset |
| 216 | ; for hole filled. |

| | | |
|---|---|---|
| 217 | .endif | |
| 218 | .xlong :value: | ; Fill in the value |
| 219 | .eval offset + 2, offset | ; Increase the offset |

| | |
|---|---|
| 220 | ; corresponding size |
| 221 | ; of dataPtr. |

| | |
|---|---|
| 222 | .endm |
| 223 | ;# ======== C55_cinitLong ======== |
| 224 | ; Initialize a long in a cinit record. |
| 225 | |
| 226 | ; Parameters |
| 227 | ; value: value to which the record must be initialized |
| 228 | ;# |
| 229 | ;# Preconditions: |
| 230 | ;# none |
| 231 | ;# |
| 232 | ;# Postconditions: |
| 233 | ;# |
| 234 | ;# |
| 235 | |
| 236 | C55_cinitLong .macro value |

| | |
|---|---|
| 237 | CHK_nargs “CINIT”, value |
| 238 | .if (offset & 0×1) ; if at odd offset |

| | |
|---|---|
| 239 | .word 0×dead ; fill in the hole |
| 240 | .eval offset + 1, offset |

| | |
|---|---|
| 241 | ; increase the offset |
| 242 | ; for hole filled. |

| | | |
|---|---|---|
| 243 | .endif | |
| 244 | .xlong :value: | ; Fill in the value |
| 245 | eval offset + 2, offset | ; Increase the offset |

| | |
|---|---|
| 246 | ; corresponding size |
| 247 | ; of dataPtr. |

| | |
|---|---|
| 248 | .endm |
| 249 | |
| 250 | ;# ======== C55_cinitInt ======== |
| 251 | ; Initialize a long in a cinit record. |
| 252 | |
| 253 | ; Parameters |
| 254 | ; value: value to which the record must be initialized |
| 255 | ;# |
| 256 | ;# Preconditions: |
| 257 | ;# none |
| 258 | ;# |
| 259 | ;# Postconditions: |
| 260 | ;# |
| 261 | ;# |
| 262 | |
| 263 | C55_cinitInt .macro value |

| 264 | CHK_nargs “CINIT”, value | |
|---|---|---|
| 265 | .word value | ; Fill in the value |
| 266 | .eval offset + 1. offset | ; Increase the offset |

| | |
|---|---|
| 267 | ; corrresponding size |
| 268 | ; of dataPtr. |

| | |
|---|---|
| 269 | .endm |
| 270 | |
| 271 | ;# ======== C55_cinitArg ======== |
| 272 | ; Initialize a long in a cinit record. |
| 273 | |
| 274 | ; Parameters |
| 275 | ; value: value to which the record must be initialized |
| 276 | ;# |
| 277 | ;# Preconditions: |
| 278 | ;# none |
| 279 | ;# |
| 280 | ;# Postconditions: |
| 281 | ;# |
| 282 | ;# |
| 283 | |
| 284 | C55_cinitArg .macro value |

| | |
|---|---|
| 285 | CHK_nargs “CINIT”, value |
| 286 | C55_cinitDataPtr value |

| 287 | .endm | |
|---|---|---|
| 288 | | |
| 289 | ;# ======== C55_allocateObject ======== | |
| 290 | ; Allocates space in an uninitialized section for the object. | |
| 291 | | |
| 292 | ; Parameters | |
| 293 | ; cinitAlign: | Alignment constraints for cinit record |
| 294 | ; isObjAligned: Alignment constraint for the object. This indicates | |
| 295 | ; | if objects members or any of its sub objects have |
| 296 | ; | members that have alignment constraints. |
| 297 | ; objAddr: | Is the addr of the object |
| 298 | ; size: It is the size of the object | |
| 299 | ; section: | The section where the object should exists. |

| | |
|---|---|
| 300 | ;# |
| 301 | ;# Preconditions: |
| 302 | ;# none |
| 303 | ;# |
| 304 | ;# Postconditions: |
| 305 | ;# |
| 306 | ;# |
| 307 | C55_allocateObject .macro isObjAligned, objAddr, size, section |

| 308 | CHK_nargs “CINIT”, section | |
|---|---|---|
| 309 | | |
| 310 | .eval size, objSize | ; This is the size of |

| | |
|---|---|
| 311 | ; .object |

| | | |
|---|---|---|
| 312 | .if(isObjAligned = 2) | ; Does the Obj require alignment |

| | | |
|---|---|---|
| 313 | .if(objSize & 0×1) | : if the cinit size is odd |

| | |
|---|---|
| 314 | eval objSize + 1, objSize ; Make it even |

| | |
|---|---|
| 315 | .endif |

| | |
|---|---|
| 316 | .endif |
| 317 | |

| | |
|---|---|
| 318 | objAddr .usect “:section:”, objSize, 0, isObjAligned ; allocate |

| | |
|---|---|
| 319 | ; space for object. |

| | | |
|---|---|---|
| 320 | .endm | |
| 321 | .endif | ; endif for CINIT inclusion |

TABLE 2

| | |
|---|---|
| 1 | ; Pipe Manager. |
| 2 | ; |
| 3 | ; Pipes allow two clients (a producer (writer) and a consumer (reader)) to |
| 4 | ; transfer frames of data without copying the data. |
| 5 | ; |
| 6 | ; The consumer (reader) does the following: |
| 7 | ; PIP_get &pipe |
| 8 | ; use pipereaderSize words of data from the frame at pipe.readerAddr |
| 9 | ; PIP_free &pipe |
| 10 | ; |
| 11 | ; The producer (writer) does the following: |
| 12 | ; PIP_alloc &pipe |
| 13 | ; fill the frame at pipe.writerAddr with up to pipe.writerSize words |
| 14 | ; set pipe.writerSize to the actual number of words in frame |
| 15 | ; PIP_put &pip |
| 16 | ; |
| 17 | ; The fields readerNumprames and writerNumFrames of PIP object |
| 18 | ; represent the number of full and empty frames respectively. |
| 19 | ; |
| 20 | ; The pipe manager allows for probing of data transferred through each |
| 21 | ; pipe. This probing is accomplished using the PIP_<read\|write>probeSET; ; and |
| | PIP_<read\|write>probeCLR operations which attach a separate PIP; ; ; probe to the specified pipe. |
| 22 | ; |

| | |
|---|---|
| 23 | .if($isdefed(“PIP_”) = 0) ; prevent multiple includes of this file |

| | |
|---|---|
| 24 | PIP_ .set 1 |
| 25 | |

| | |
|---|---|
| 26 | .include chk.h55 |
| 27 | .include fxn.h55 |
| 28 | .include cinit.h55 |
| 29 | .include gbl.h55 |
| 30 | .include sts.h55 |

| | |
|---|---|
| 31 | ;;;;;;;;;;;;;;;;;;;;;;;;;;;;;;;;;;;;;;;;;;;;;;;;;;;;;;;;;;;;;;;;;;;; |
| 32 | ; Define alignment constraints for structure in PIP_Obj |
| 33 | ;;;;;;;;;;;;;;;;;;;;;;;;;;;;;;;;;;;;;;;;;;;;;;;;;;;;;;;;;;;;;;;;;;;; |
| 34 | |
| 35 | isPipsockAligned .set 2 |
| 36 | isPipAligned .set 2 |

| | |
|---|---|
| 37 | if ($isdefed(“_large_model”)) |

| | |
|---|---|
| 38 | isPipdescAligned .set 2 |

| | |
|---|---|
| 39 | .else |

| | |
|---|---|
| 40 | isPipdescAligned .set 1 |

| | |
|---|---|
| 41 | .endif |
| 42 | |

| 43 | ; | |
|---|---|---|
| 44 | ; ======== PIP_Sock ======== | |
| 45 | ; | |
| 46 | | |
| 47 | PIP_Sock | .struct |

| | | |
|---|---|---|
| 48 | tprobe | DataPtr 1 |

| | | | |
|---|---|---|---|
| 49 | frameAddr | DataPtr 1 | ; Address of the frame |

| | | | |
|---|---|---|---|
| 50 | frameSize | Int 1 | ; Size of the frame |

| | | | |
|---|---|---|---|
| 51 | curDesc | DataPtr 1 | ; Current descriptor |
| 52 | pFxnObj | DataPtr 1 | pointer to function Obj |

| | | | |
|---|---|---|---|
| 53 | numFrames | Int 1 | ; number of frames |

| | | | |
|---|---|---|---|
| 54 | gprobe | DataPtr 1 | ; grobe. not yet used |

| | | | |
|---|---|---|---|
| 55 | pNumFrames | DataPtr 1 | ; ptr to numFrames |

| | | |
|---|---|---|
| 56 | pad | .align isFxnAligned |

| 57 | fxnObj | .tag FXN_Obj ; function object | |
|---|---|---|---|
| 58 | stsHdl | DataPtr 1 | ; Handle to STS object |

| | | |
|---|---|---|
| 59 | endPad | .align isPipsockAligned |

| 60 | PIP_A_SOCKSIZE .endstruct | |
|---|---|---|
| 61 | | |
| 62 | ; | |
| 63 | ======== PIP_Obj ======== | |
| 64 | ; | |
| 65 | | |
| 66 | PIP_Obj | .struct |

| 67 | threshold | Int 1 | | ; (Uns) max size of frames in pip |
|---|---|---|---|---|
| 68 | pad0 | .align isPipsockAligned | | |
| 69 | readerSock | .tag | PIP_Sock | ; Reader Socket |
| 70 | pad1 | .align isPipsockAligned | | |
| 71 | writerSock | .tag | PIP_Sock | ; Writer Socket |

| | | |
|---|---|---|
| 72 | endPad | . align isPipAligned |
| 73 | PIP_A_OBJSIZE | .endstruct |

| 74 | ;;;;;;;;;;;;;;;;;;;;;;;;;;;;;;;;;;;;;;;;;;;;;;;;;;;;;;;;;;;;;;;;;;;; | | |
|---|---|---|---|
| 75 | ; readerSock has the following members | | |
| 76 | ; preaderTakeProbe, readerAddr readerSize, readerCurdesc, | | |
| 77 | ; pnotifyReader, readerNumFrames preaderGiveProbe .pwriterNumFrames | | |
| 78 | ; notifyWriter, preaderSts | | |
| 79 | ; | | |
| 80 | ; writerSock has the following members | | |
| 81 | ; pwriterTakeProbe, writerAddr, writerSize ,writerCurdesc | | |
| 82 | ; pnotifyWriter, writerNumFrames, pwriterGiveProbe | | |
| 83 | ; preaderNumFrames ,notifyReader, pwriterSts | | |
| 84 | ;;;;;;;;;;;;;;;;;;;;;;;;;;;;;;;;;;;;;;;;;;;;;;;;;;;;;;;;;;;;;;;;;;;; | | |
| 85 | | | |
| 86 | PIPDESC_Obj .struct | | |
| 87 | addr | DataPtr 1 | |
| 88 | size | Int | 1 |
| 89 | next | DataPtr 1 | |

| 90 | PIPDESC_A_OBJSIZE .endstruct | | |
|---|---|---|---|
| 91 | | | |
| 92 | PIPDESC_BASE | .set | PIPDESC_Obj.addr |
| 93 | PIPDESC_O_SIZE | .set | PIPDESC_Obj.size-PIPDESC_BASE |
| 94 | PIPDESC_O_NEXT | .set | PIPDESC_Obj.next-PIPDESC_BASE |
| 95 | PIPDESC_SIZE | .set | PIPDESC_A_OBJSIZE |
| 96 | | | |
| 97 | ; | | |
| 98 | ; ======== PIP OFFSETS ======== | | |
| 99 | ; | | |
| 100 | | | |
| 101 | PIP_O_BASE | .set | PIP_Obj.threshold |
| 102 | PIP_O_TPROBE | .set | PIP_Sock.tprobe |
| 103 | PIP_O_FADDR | .set | PIP_Sock.frameAddr |
| 104 | PIP_O_FSIZE | .set | PIP_Sock.frameSize |

| | | | |
|---|---|---|---|
| 105 | PIP_O_CURDESC | .set | PIP_Sock.curDesc |
| 106 | PIP_O_PFXNOBJ | .set | PIP_Sock.pFxnObj |

| | | | |
|---|---|---|---|
| 107 | PIP_O_NUMFRAMES | .set | PIP_Sock.numFrames |
| 108 | PIP_O_GPROBE | .set | PIP_Sock.gprobe |
| 109 | PIP_O_PNUMFRAMES | .set | PIP_Sock.pNumFrames |
| 110 | PIP_O_FXNOBJ | .set | PIP_Sock.fknObj |
| 111 | PIP_O_STSHDL | .set | PIP_Sock.stsHdl |
| 112 | PIP_O_HDBASE | .set | PIP_Obj.readerSock - PIP_O_BASE |
| 113 | PIP_O_TLBASE | .set | PIP_Obj.writerSock - PIP_O_BASE |
| 114 | PIP_READPTR | .set | PIP_O_HDBASE+PIP_O_FADDR |
| 115 | PIP_READCNT | .set | PIP_O_HDBASE+PIP_O_FSIZE |
| 116 | PIP_READCURDESC | .set | PIP_O_HDBASE+PIP_O_CURDESC |

| | | | |
|---|---|---|---|
| 117 | PIP_READSTSHDL | .set | PIP_O_HDBASE+PIP_O_STSHDL |

| | | | |
|---|---|---|---|
| 118 | PIP_WRITECURDESC | .set | PIP_O_TLBASE+PIP_O_CURDESC |

| | | | |
|---|---|---|---|
| 119 | PIP_READFXNOBJ | .set | PIP_O_HDBASE+PIP_O_FXNOBJ |
| 120 | PIP_WRITEPTR | .set | PIP_O_TLBASE+PIP_O_FADDR |
| 121 | PIP_WRITECNT | .set | PIP_O_TLBASE+PIP_O_FSIZE |
| 122 | PIP_WRITECURDESC | .set | PIP_O_TLBASE+PIP_O_CURDESC |
| 123 | PIP_WRITESTSHDL | .set | PIP_O_TLBASE+PIP_O_STSHDL |
| 124 | PIP_WRITEFXNOBJ | .set | PIP_O_TLBASE+PIP_O_FXNOBJ |
| 125 | | | |

| | | | |
|---|---|---|---|
| 126 | PIP_FULLBUFS | .set | PIP_O_HDBASE+PIP_O_NUMFRAMES |

| | | | |
|---|---|---|---|
| 127 | PIP_EMPTYBUFS | .set | PIP_O_TLBASE+PIP_O_NUMFRAMES |

| | | | |
|---|---|---|---|
| 128 | PIP_SIZE | .set | PIP_A_OBJSIZE |
| 129 | | | |

| | |
|---|---|
| 130 | .mmregs |
| 131 | |

| | |
|---|---|
| 132 | .global PIP_F_give, PIP_F_take, PIP_F_probe, PIP_F_start |
| 133 | global PIP_D_tabbeg, PIP_D_tablen |
| 134 | global PIP_A_TABBEG, PIP_A_TABEND, PIP_A_TABLEN |
| 135 | |

| 136 | ; | |
|---|---|---|
| 137 | ; # ======== PIP_Obj ======== | |
| 138 | ; Create a pipe object. | |
| 139 | ; | |
| 140 | ; name - name of pipe object | |
| 141 | ;id | - pipe id |
| 142 | ; buf | - preallocated buffer (or <NULL> if PIP_Obj should create) |
| 143 | ; framesize | - size of each frame in pipe (in words) |
| 144 | ; numframes- number of frames in pipe | |
| 145 | ; stsend | - which end STS stats are accumulated |
| 146 | ; notifyWriter - function to call whenever PIP_free is called | |
| 147 | ; nwarg* | - arguments to notify Writer function |

| | |
|---|---|
| 148 | ; notifyReader - function to call whenever PIP_put is called |
| 149 | ; nrarg* - arguments to notifyReader function |
| 150 | ; |
| 151 | ; Note: PIP probe functionality is *not* implemented for this target |
| 152 | ; |
| 153 | ;# Preconditions: |
| 154 | ;# none |
| 155 | ;# |
| 156 | ;# Postconditions: |
| 157 | ;# none |
| 158 | ;# |
| 159 | ; |

| | |
|---|---|
| 160 | .asg “:GBL_Obj$regs:,:FXN_Obj$regs:,:STS_Obj$regs:”, PIP_Obj$regs |

| | |
|---|---|
| 161 | PIP_Obj.macro cflag, name, id, buf, framesize, numframes, stsend, notifyWriter, nwarg0, nwarg1, |
| | notifyReader, nrarg0, nrarg1 |
| 162 | |

| | |
|---|---|
| 163 | ;;;;;;;;;;;;;;;;;;;;;;;;;;;;;;;;;;;;;;;;;;;;;;;;;;;;;;;;;;;;;;;;;;;; |
| 164 | ; These globals are only for debug purposes. They are |
| 165 | ; not used by host tool. |
| 166 | ;;;;;;;;;;;;;;;;;;;;;;;;;;;;;;;;;;;;;;;;;;;;;;;;;;;;;;;;;;;;;;;;;;;; |
| 167 | |
| 168 | .global :name:, :name:$rd, :name:$wr, :name:$dtab, :name:$buf |
| 169 | .global :name:$rdstshdl, :name:$wrstshdl |

| | |
|---|---|
| 170 | .global :name:$rdcurdesc, :name:$rdaddr, :name:$rdsize |

| | |
|---|---|
| 171 | global :name:$wrcurdesc, :name:$wraddr, :name:$wrsize |
| 172 | |

| | |
|---|---|
| 173 | .if(:cflag: = 0) |

| | |
|---|---|
| 174 | .mexit |

| | |
|---|---|
| 175 | .endif |
| 176 | |
| 177 | .if($symcmp(“:buf:”, “<NULL>”) = 0) |

| 178 | GBL_Obj :name:$buf, :framesize:*:numframes:,.pip:id: | |
|---|---|---|
| 179 | .asg | :name:$buf, buf |

| | |
|---|---|
| 180 | .endif |
| 181 | |

| | |
|---|---|
| 182 | C55_allocateObject isPipAligned,:name:, PIP_SIZE, “.pip” |

| | |
|---|---|
| 183 | ; Allocate space |
| 184 | ; for the PIP Object |
| 185 | |

| | |
|---|---|
| 186 | ;;;;;;;;;;;;;;;;;;;;;;;;;;;;;;;;;;;;;;;;;;;;;;;;;;;;;;;;;;;;;;;;;;;; |
| 187 | ; allocate space for threshold/framesize & cinit the same ; |
| 188 | ;;;;;;;;;;;;;;;;;;;;;;;;;;;;;;;;;;;;;;;;;;;;;;;;;;;;;;;;;;;;;;;;;;;; |
| 189 | |

| | |
|---|---|
| 190 | C55_cinitHeader CINITALIGN, isPipAligned, :name:, |
| | PIP_SIZE,DATAPAGE |
| 191 | |

| | |
|---|---|
| 192 | ;;;;;;;;;;;;;;;;;;;;;;;;;;;;;;;;;;;;;;;;;;;;;;;;;;;;;;;;;;;;;;;;;;;; |
| 193 | ; Define various ptr values, that would serve to fill the; |
| 194 | ; the cinit records. |
| 195 | ;;;;;;;;;;;;;;;;;;;;;;;;;;;;;;;;;;;;;;;;;;;;;;;;;;;;;;;;;;;;;;;;;;;; |
| 196 | |

| | | |
|---|---|---|
| 197 | :name:$rd: .set :name: + PIP_O_HDBASE | ; assign the reader |

| 198 | :name:$rdstshdl .set :name: + PIP_READSTSHDL; sts handle value. | | |
|---|---|---|---|
| 199 | :name:$rdcurdesc | .set :name: + PIP_READCURDESC; .reader curdesc | |
| 200 | :name:$rdaddr | .set :name: + PIP_READPTR | ; reader addr |
| 201 | :name:$rdsize | .set :name: + PIP_READCNT | ; reader size |
| 202 | | | |

| | | | |
|---|---|---|---|
| 203 | :name:$wr | set :name: + PIP_O_TLBASE | ; assign writer ptr |

| | | |
|---|---|---|
| 204 | :name:$wrstshdl .set :name: + PIP_WRITESTSHDL | ; This is the writer |

| 205 | :name:$wrcurdesc .set :name: + PIP_WRITECURDESC ; .reader curdesc | | |
|---|---|---|---|
| 206 | :name:$wraddr | set :name: + PIP_WRITEPTR | ; reader addr |
| 207 | :name:$wrsize | .set :name: + PIP_WRITECNT | ; reader size |
| 208 | | | ; sts handle value. |

| 209 | :name:$rdfxn | set :name: + PIP_READFXNOBJ ; This is the rdrxn | |
|---|---|---|---|
| 210 | :name:$wrfxn | .set :name: + PIP_WRITEFXNOBJ | ; This is the wrtrfxn |
| 211 | | | |

| 212 | ;;;;;;;;;;;;;;;;;;;;;;;;;;;;;;;;;;;;;;;;;;;;;;;;;;;;;;;;;;;;;;;;;;;; | | |
|---|---|---|---|
| 213 | ; Start the cinit recrod | | ; |
| 214 | ;;;;;;;;;;;;;;;;;;;;;;;;;;;;;;;;;;;;;;;;;;;;;;;;;;;;;;;;;;;;;;;;;;;; | | |
| 215 | | | |
| 216 | C55_cinitBegin isPipAligned | | |
| 217 | | | |
| 218 | ;;;;;;;;;;;;;;;;;;;;;;;;;;;;;;;;;;;;;;;;;;;;;;;;;;;;;;;;;;;;;;;;;;;; | | |
| 219 | ; cinit reader-side (excluding FXN_Obj & ; | | |
| 220 | ; StsPtr) & cinit the | same | ; |

| | |
|---|---|
| 221 | ;;;;;;;;;;;;;;;;;;;;;;;;;;;;;;;;;;;;;;;;;;;;;;;;;;;;;;;;;;;;;;;;;;;; |

| | | | |
|---|---|---|---|
| 222 | C55_cinitInt | :framesize: | ; threshold allocation |
| 223 | | | |

| | |
|---|---|
| 224 | PIPSOCK_cinitObj framesize, :name:$dtab, :name:$wr + PIP_O_FXNOBJ,0, :name:$wr + |

| | PIP_O_NUMFRAMES, :notifyWriter:, :nwarg0:, :nwarg1:. :stsend:, “reader”, :name:$sts |
|---|---|
| 225 | |
| 226 | ;;;;;;;;;;;;;;;;;;;;;;;;;;;;;;;;;;;;;;;;;;;;;;;;;;;;;;;;;;;;;;;;;;;; |

| 227 | ; cinit writer-side (excluding FXN_Obj & ; | |
|---|---|---|
| 228 | StsPtr) & cinit the same | ; |

| | |
|---|---|
| 229 | ;;;;;;;;;;;;;;;;;;;;;;;;;;;;;;;;;;;;;;;;;;;;;;;;;;;;;;;;;;;;;;;;;;;; |
| 230 | |

| | |
|---|---|
| 231 | PIPSOCK_cinitObj framesize, :name:$dtab, :name:$rd + PIP_O_FXNOBJ, |

numframes,:name:$rd + PIP_O_NUMFRAMES, :notifyReader:, :nrarg0:, :nrarg1:, :stsend:, “writer”,
:name:$sts

| | |
|---|---|
| 232 | |
| 233 | C55_cinitEnd isPipAligned |
| 234 | ;;;;;;;;;;;;;;;;;;;;;;;;;;;;;;;;;;;;;;;;;;;;;;;;;;;;;;;;;;;;;;;;;;;; |
| 235 | ; |
| 236 | ; put PIP descriptors into .bss section |
| 237 | ; |
| 238 | ; addr[i] |
| 239 | ; size[i] |
| 240 | ; next [i] |
| 241 | ; |
| 242 | ;;;;;;;;;;;;;;;;;;;;;;;;;;;;;;;;;;;;;;;;;;;;;;;;;;;;;;;;;;;;;;;;;;;; |
| 243 | |
| 244 | .global :name:$dtab |
| 245 | |
| 246 | .bss :name:$dtab, (PIPDESC_SIZE * :numframes:), STD_TARGWORDMAUS, |

isPipdescAligned

| | |
|---|---|
| 247 | |
| 248 | .sect “.cinit” |
| 249 | |

| 250 | | .var temp0, temp1, boff |
|---|---|---|
| 251 | | .eval 0, temp0 |
| 252 | | eval 0, temp1 |
| 253 | | .eval 0, boff |
| 254 | .eval | :numframes: * (PIPDESC_SIZE) , temp0 |

| | |
|---|---|
| 255 | .eval PIPDESC_A_OBJSIZE , temp1 |
| 256 | |

| | |
|---|---|
| 257 | C55_cinitHeader 1, isPipdescAligned, :name:$dtab, :temp0:, 0 |

| | |
|---|---|
| 258 | ; offset to start of next desc. |
| 259 | |

| | |
|---|---|
| 260 | .loop :numframes:-1 |

| | | |
|---|---|---|
| 261 | C55_cinitBegin isPipdescAligned | |
| 262 | C55_cinitDataPtr :buf:+:boff: | ; addr[i] |
| 263 | C55_cinitInt :framesize: | ; size [i] |
| 264 | C55_cinitDataPtr :name:$dtab + :temp1: | ; next [i] |
| 265 | C55_cinitEnd isPipdescAligned | |

| | |
|---|---|
| 266 | .eval :boff:+(:framesize: * (STD_TARGWORDMAUS)), boff |
| 267 | .eval :temp1: + (PIPDESC_SIZE * STD_TARGWORDMAUS), temp1 |

| | |
|---|---|
| 268 | .endloop |
| 269 | |

| 270 | ;;;;;;;;;;;;;;;;;;;;;;;;;;;;;;;;;;;;;;;;;;;;;;;;;;;;;;;;;;;;;;;;;;;; | |
|---|---|---|
| 271 | ; cinit data for the very last descriptor triplet | |
| 272 | ;;;;;;;;;;;;;;;;;;;;;;;;;;;;;;;;;;;;;;;;;;;;;;;;;;;;;;;;;;;;;;;;;;;; | |
| 273 | | |
| 274 | C55_cinitBegin isPipdescAligned | |
| 275 | C55_cinitDataPtr:buf:+:boff: | ; addr[n] |

| | | | |
|---|---|---|---|
| 276 | C55_cinitInt | :framesize: | ; size[n] |

| | | |
|---|---|---|
| 277 | C55_cinitDataPtr :name:$dtab | ; next[n] |
| 278 | C55_cinitEnd isPipdescAligned | |
| 279 | | |

| | |
|---|---|
| 280 | ;;;;;;;;;;;;;;;;;;;;;;;;;;;;;;;;;;;;;;;;;;;;;;;;;;;;;;;;;;;;;;;;;;;; |
| 281 | ; allocate/cinit (via STS_Obj macro) Statistics obj for this PIP |
| 282 | ;;;;;;;;;;;;;;;;;;;;;;;;;;;;;;;;;;;;;;;;;;;;;;;;;;;;;;;;;;;;;;;;;;;; |
| 283 | |

| | |
|---|---|
| 284 | .if ($symcmp(“:stsend:”, “reader”) = 0) |

| | |
|---|---|
| 285 | STS_Obj 1, :name:$sts, 0, 0, 0 |

| | |
|---|---|
| 286 | .endif |
| 287 | .if($symcmp(“:stsend:”, “writer”) = 0) |

| | |
|---|---|
| 288 | STS_Obj 1, :name:$sts, 0, 0, 0 |

| | |
|---|---|
| 289 | .endif |
| 290 | .eval PIP$pipCount + 1, PIP$pipCount ; increment the number |

| | |
|---|---|
| 291 | ; of PIP objects. |
| 292 | |

| | |
|---|---|
| 293 | .endm |
| 294 | |

| 295 | ;# ======== PIPSOCK_cinitOBj ======== | |
|---|---|---|
| 296 | ; Create cinit record for PIP sockets | |
| 297 | ; | |
| 298 | ; Parameters | |
| 299 | ; framesize: | Size of the frame |

| | | |
|---|---|---|
| 300 | ; curdesc: | The value of curdesc |

| | | |
|---|---|---|
| 301 | ; pFxnObj: | Pointer to FXN_Obj |

| | | |
|---|---|---|
| 302 | ; pNumFrames: | 10 Pointer to numFrames |
| 303 | ; notifyFunc: | The PIP notify function |

| 304 | ; notifyFuncArg0: First argument of notify function | |
|---|---|---|
| 305 | ; notifyFuncArg1: Second argument of notify function | |
| 306 | ; stsEnd: The end at which sts obj is attached to PIP | |
| 307 | ; | This comes from gconf |

| | |
|---|---|
| 308 | ; endType :Reader/Writer |
| 309 | ; stsAddr :Address of sts object |
| 310 | ; |
| 311 | ;# |
| 312 | ;# Preconditions: |
| 313 | ;# none |
| 314 | ;# |
| 315 | ;# Postconditions: |
| 316 | ;# |
| 317 | ;# Constraints and Calling Environment: |
| 318 | ;# |
| 319 | |
| 320 | PIPSOCK_cinitObj .macro frameSize, curDesc, pFxnObj, numFrames, pNumFrames, |
| | notifyFunc , notifyFuncArg0, notifyFuncArg1, stsEnd, endType, stsAddr |
| 321 | |

| | |
|---|---|
| 322 | ;CHK_nargs “PIPSOCK”, stsAddr |

| | |
|---|---|
| 323 | C55_cinitBegin isPipsockAligned |

| | | |
|---|---|---|
| 324 | C55_cinitDataPtr 0 | ; take-probe |
| 325 | C55_cinitDataPtr 0 | ; addr |

| | | |
|---|---|---|
| 326 | C55_cinitInt frameSize | ; size |

| | | |
|---|---|---|
| 327 | C55_cinitDataPtr curDesc | ; curdesc |
| 328 | C55_cinitDataPtr pFxnObj | ; pFxnOBj |
| 329 | C55_cinitInt numFrames | ; reader numframes |
| 330 | C55_cinitDataPtr 0 | ; reader give-probe |

| | |
|---|---|
| 331 | C55_cinitDataPtrpNum Frames ; writer pnumframes |

| | |
|---|---|
| 332 | ;(=&writerNumFrames) |

| | |
|---|---|
| 333 | ;;;;;;;;;;;;;;;;;;;;;;;;;;;;;;;;;;;;;;;;;;;;;;;;;;;;;;;;;;;;;;;;;;;; |

| | |
|---|---|
| 334 | ; Generate value section for the FXN_object; |

| | |
|---|---|
| 335 | ;;;;;;;;;;;;;;;;;;;;;;;;;;;;;;;;;;;;;;;;;;;;;;;;;;;;;;;;;;;;;;;;;;;; |
| 336 | |
| 337 | FXN_cinitObj notifyFunc, notifyFuncArg0, notifyFuncArg1 |
| 338 | |
| 339 | ;;;;;;;;;;;;;;;;;;;;;;;;;;;;;;;;;;;;;;;;;;;;;;;;;;;;;;;;;;;;;;;;;;;; |

| | |
|---|---|
| 340 | ; Continue Filling the rest of the object ; |
| 341 | ;;;;;;;;;;;;;;;;;;;;;;;;;;;;;;;;;;;;;;;;;;;;;;;;;;;;;;;;;;;;;;;;;;;; |
| 342 | |
| 343 | if ($symcmp(“:stsEnd:”, “:endType:”) = 0) |

| | |
|---|---|
| 344 | C55_cinitDataPtr stsAddr |

| | |
|---|---|
| 345 | .else |

| | |
|---|---|
| 346 | C55_cinitDataPtr 0 |

| | |
|---|---|
| 347 | .endif |

| | |
|---|---|
| 348 | C55_cinitEnd isPipsockAligned |
| 349 | .endm |

| | |
|---|---|
| 350 | ; |
| 351 | ;# ======== PIP_config ======== |
| 352 | ; |
| 353 | ;# |
| 354 | ;# Preconditions: |
| 355 | ;# none |
| 356 | ;# |
| 357 | ;# Postconditions: |
| 358 | ;# none |
| 359 | ;# |
| 360 | ; |

| | |
|---|---|
| 361 | .asg “”, PIP_config$regs |

| | |
|---|---|
| 362 | PIP_config .macro _gNumEmbed, _gNextId |

| | | | |
|---|---|---|---|
| 363 | .asg | 0, PIP$pipCount | ; This indicate the |

| | |
|---|---|
| 364 | ; the number of |
| 365 | ; PIP objects. |
| 366 | |

| | |
|---|---|
| 367 | .endm |
| 368 | |

| | |
|---|---|
| 369 | ; |
| 370 | ;# ========PIP_end ======== |
| 371 | ; Invoked at the end of all other configuration |
| 372 | ; declarations. |
| 373 | ; |
| 374 | ;# |
| 375 | ;# Preconditions: |
| 376 | ;# none |
| 377 | ;# Postconditions: |
| 378 | ;# none |
| 379 | ;# |
| 380 | ; |

| | |
|---|---|
| 381 | .asg “”, PIP end$regs |

| | |
|---|---|
| 382 | PIP_end .macro |

| | |
|---|---|
| 383 | .endm |
| 384 | |
| 385 | ; |
| 386 | ;# ======== PIP_int ======== |
| 387 | ; |
| 388 | ;# Preconditions: |
| 389 | ;# none |
| 390 | ;# |
| 391 | ;# Postconditions: |
| 392 | ;# none |
| 393 | ;# |
| 394 | ; |
| 395 | .asg “”, PIP_init$regs |

| | |
|---|---|
| 396 | PIP_int .macro |

| | |
|---|---|
| 397 | .endm |
| 398 | |
| 399 | ; |
| 400 | ;# ======== PIP_alloc ======== |
| 401 | ; |
| 402 | ;# |
| 403 | :# Preconditions: |
| 404 | ;# xar0 = address of the pipe object |
| 405 | ;# pipe.writerNumFrames > 0 |
| 406 | ;# |
| 407 | ;# Postconditions: |
| 408 | ;# none |
| 409 | ;# |
| 410 | ;# Constraints and Calling Environment: |
| 411 | ;# Before calling PIP_alloc a function should check the |
| 412 | ;# writerNumFrames member of the PIP_Obj structure to make |
| 413 | ;# sure it is greater than 0 (at least one empty frame is |
| 414 | :# available) |
| 415 | ;# |
| 416 | ;# Note: |
| 417 | ;# registers used by ‘notify Writer’ functions might be modified |
| 418 | ;# too. Since such a function can be “C”, it'd imply all registers |
| 419 | ;# considered as trashable by C compiler |
| 420 | ;# |
| 421 | ; |
| 422 | .asg “xar0,PIP_F_take$regs”, PIP_alloc$regs |

| | | |
|---|---|---|
| 423 | PIP_alloc | .macro dummy |

| | |
|---|---|
| 424 | CHK_void PIP_alloc, dummy |
| 425 | |

| | | |
|---|---|---|
| 426 | .if(.MNEMONIC) | ;if MNEMONIC assembler |

| | | |
|---|---|---|
| 427 | aadd #PIP_EMPTYBUFS, ar0 | ; ar0 = &writerNumFrames |

| | | |
|---|---|---|
| 428 | .else | ;if ALGEBRAIC |

| | | |
|---|---|---|
| 429 | mar(ar0 + #PIP_EMPTYBUFS) | ; ar0 = &writerNumFrames |

| | | |
|---|---|---|
| 430 | .endif | ; endif MNEMONIC |
| 431 | | |

| | | |
|---|---|---|
| 432 | call PIP_F_take | ; call PIP_F_take |
| 433 | | |
| 434 | .endm | |
| 435 | | |

| | |
|---|---|
| 436 | ; |
| 437 | ;# ======== PIP_put ======== |
| 438 | ; |
| 439 | ;# |
| 440 | ;# Preconditions for large model: |
| 441 | ;# xar0 = address of the pipe object |
| 442 | ;# |
| 443 | ;# Postconditions: |
| 444 | ;# none |
| 445 | ;# |
| 446 | ;# Note: |
| 447 | ;# registers used by ‘notifyReader’ functions might be modified too. |
| 448 | ;# Since such a function can be “C”, it'd imply all registers |
| 449 | ;# considered as trashable by C compiler |
| 450 | ;# |
| 451 | ; |

| | |
|---|---|
| 452 | .asg “xar0,:PIP_F give$regs:”, PIP_put$regs |

| | | |
|---|---|---|
| 453 | PIP_put | .macro dummy |

| | | |
|---|---|---|
| 454 | CHK_void | PIP_put, dummy |
| 455 | | |

| | | |
|---|---|---|
| 456 | .if (MNEMONIC) | ;if MNEMONIC assembler |

| | |
|---|---|
| 457 | aadd #(PIP_O_TLBASE + PIP_O_CURDESC),ar0 |

| 458 | | ; ar0 = &writerCurdesc |
|---|---|---|
| 459 | .else | ; if ALGEBRAIC |

| | |
|---|---|
| 460 | mar(ar0 + #(PIP_O_TLBASE + PIP__O_CURDESC)) |

| 461 | ; ar0 = &writerCurdesc | |
|---|---|---|
| 462 | endif | ; endif MNEMONIC |
| 463 | | |

| | | |
|---|---|---|
| 464 | call PIP_F_give | ; call PIP_F_give |
| 465 | | |
| 466 | .endm | |
| 467 | | |

| | |
|---|---|
| 468 | ; |
| 469 | ;# ======== PIP_get ======== |
| 470 | ; |
| 471 | ;# |
| 472 | ;# Preconditions for large: |
| 473 | ;# xar0 = address of the pipe object |
| 474 | ;# pipe.readerNumFrames > 0 |
| 475 | ;# |
| 476 | ;# Postconditions: |
| 477 | ;# none |
| 478 | ;# |
| 479 | ;# Constraints and Calling Environment: |
| 480 | ;# Before calling PIP_get, a function should check the |
| 481 | ;# readerNumFrames member of the PIP_Obj structure to make sure it |
| 482 | ;# is greater than 0 (at least one full frame is available) |
| 483 | ;# |
| 484 | ;# Note: |
| 485 | ;# registers used by ‘notifyReader’ functions might be |
| 486 | ;# modified too. Since such a function can be “C”, it'd imply |
| 487 | ;# all registers considered as trashable by C compiler |
| 488 | ;# |
| 489 | ; |

| | |
|---|---|
| 490 | .asg “xar0,:PIP_F_take$regs:”, PIP_get$regs |

| | | |
|---|---|---|
| 491 | PIP_get | .macro dummy |

| | | |
|---|---|---|
| 492 | CHK_void | PIP_get, dummy |
| 493 | | |

| | | |
|---|---|---|
| 494 | .if(.MNEMONIC) | ;if MNEMONIC assembler |

| | | |
|---|---|---|
| 495 | aadd #PIP_FULLBUFS ,ar0 | ; ar0 = &readerNumFrames |

| | | |
|---|---|---|
| 496 | .else | :if ALGEBRAIC |

| | | |
|---|---|---|
| 497 | mar(ar0 + #PIP_FULLBUFS) | ; ar0 = &readerNumFrames |

| | |
|---|---|
| 498 | .endif |

| | | |
|---|---|---|
| 499 | call PIP_F take | ; call PIP_F_take |
| 500 | | |
| 501 | .endm | |
| 502 | | |

| | |
|---|---|
| 503 | ; |
| 504 | ;# ======== PIP_free ======== |
| 505 | ; |
| 506 | ;# |
| 507 | ;# Preconditions: |
| 508 | ;# xar0 = address of the pipe object |
| 509 | ;# |
| 510 | ;# Postconditions: |
| 511 | ;# none |
| 512 | ;# |
| 513 | ;# Note: |
| 514 | ;# registers used by ‘notify Writer’ functions might be |
| 515 | ;# modified too. Since such a function can be “C”, |
| 516 | ;# all registers considered as trashable by C compiler |
| 517 | ;# |
| 518 | ; |

| | |
|---|---|
| 519 | .asg “xar0,:PIP_F give$regs:”, PIP_free$regs |

| | |
|---|---|
| 520 | PIP_free .macro dummy |

| | |
|---|---|
| 521 | CHK_void PIP_free, dummy |
| 522 | |

| | | |
|---|---|---|
| 523 | .if(.MNEMONIC) | ;if MNEMONIC assembler |

| | |
|---|---|
| 524 | mar(ar0 + #(PIP_O_HDBASE + PIP_O_CURDESC)) |

| | |
|---|---|
| 525 | ; ar0 = &readerCurdesc |

| | |
|---|---|
| 526 | .else |

| | |
|---|---|
| 527 | mar(ar0 + #(PIP_O_HDBASE + PIP_O_CURDESC)) |

| | |
|---|---|
| 528 | ; ar0 = &readerCurdesc |

| | |
|---|---|
| 529 | .endif |
| 530 | |

| | | |
|---|---|---|
| 531 | call PIP_F_give | ; call PIP_F_give |
| 532 | | |
| 533 | .endm | |
| 534 | | |

| 535 | ; | |
|---|---|---|
| 536 | ,# ======== PIP_startup ======== | |
| 537 | ; | |
| 538 | ;# | |
| 539 | ;# Preconditions: | |
| 540 | ;# none | |
| 541 | ;# | |
| 542 | ;# Postconditions: | |
| 543 | ;# none | |
| 544 | ;# | |
| 545 | ;# Dependencies: | |
| 546 | ;# Must come before HWI_startup to allow pipes to be ready | |
| 547 | ;# before ISRs are taken and I/O starts. | |
| 548 | ;# Note: SWI scheduler is not yet enabled as we walk through | |
| 549 | ;# | each of the configured PIP objects and call |
| 550 | ;# | their respective notifyWriter(nwarg0, nwarg1) |
| 551 | ;# | functions. |

| | |
|---|---|
| 552 | ; |

| | |
|---|---|
| 553 | .asg “xar0,:PIP_F_start$regs:”, PIP_startup$regs |

| | | |
|---|---|---|
| 554 | PIP_startup | macro dummy |

| | | |
|---|---|---|
| 555 | CHK_void | PIP_startup, dummy |
| 556 | | |

| | |
|---|---|
| 557 | ; expand only if some PIP objects are configured |

| | | |
|---|---|---|
| 558 | .var | pipcount |
| 559 | .eval | PIP$pipCount, pipcount |
| 560 | asg | “#:pipcount:”, pipcount |

| | | |
|---|---|---|
| 561 | .if (.MNEMONIC) | ;if MNEMONIC assembler |

| | |
|---|---|
| 562 | .if((PIP$ + PIP_gNumEmbed) != 0); if PIP objects exits |

| | |
|---|---|
| 563 | .if($isdefed(“_large_model”)); if large model |

| | |
|---|---|
| 564 | mov pipcount, *(#PIP_D_tablen) |
| 565 | mov dbl(*(#PIP_D_tabbeg)),xar0 |

| 566 | | ; load xar0 with |
|---|---|---|
| 567 | | ; address of |
| 568 | | ; 1st PIP_Obj |
| 569 | .else | ; if small model |

| | |
|---|---|
| 570 | mov pipcount, *abs16(#PIP_D_tablen) |
| 571 | mov *abs16(#PIP_D_tabbeg), xar0 |

| | |
|---|---|
| 572 | ; load ar0 with address |
| 573 | ; of; 1st PIP_Obj |

| | | |
|---|---|---|
| 574 | .endif | ; endif large model |

| | | |
|---|---|---|
| 575 | call PIP_F_start | ; walk thru' table of |

| | |
|---|---|
| 576 | ; PIPs & start'em up |

| | | |
|---|---|---|
| 577 | .endif | ; endif PIP$ |

| | | |
|---|---|---|
| 578 | .else | ; if ALGREBRAIC |
| 579 | | |

| | |
|---|---|
| 580 | .if((PIP$ + PIP_gNumEmbed) != 0); if PIP objects exits |

| | |
|---|---|
| 581 | .if($isdefed(“_large_model”)); if large model |

| | |
|---|---|
| 582 | *(#PIP_D_tablen) = pipcount |

| | |
|---|---|
| 583 | xar0 = dbl(*(#PIP_D_tabbeg)) |

| | |
|---|---|
| 584 | ;load xar0 with |
| 585 | ; address of |
| 586 | ; 1st PIP_Obj |

| | | |
|---|---|---|
| 587 | .else | ; if small model |

| | |
|---|---|
| 588 | *abs16(#PIP_D_tablen) = pipcount |

| | |
|---|---|
| 589 | ar0 = *abs16(#PIP_D_tabbeg) |

| | |
|---|---|
| 590 | ;load ar0 with address |
| 591 | ;of ; 1st PIP_Obj |

| | | |
|---|---|---|
| 592 | .endif | ; endif large model |

| | |
|---|---|
| 593 | call PIP_F_start; walk thru' table of |

| | |
|---|---|
| 594 | ; PIPs & start'em up |

| | | |
|---|---|---|
| 595 | .endif | ; endif PIP$ |

| | | |
|---|---|---|
| 596 | .endif | ; endif MNEMONIC |
| 597 | | |
| 598 | .endm | |
| 599 | | |

| | |
|---|---|
| 600 | ; |
| 601 | ;# ======== PIP_readprobeSET ======== |
| 602 | ; Attach named probe to the named pipe's reader |
| 603 | ;# |
| 604 | ;# Preconditions: |
| 605 | ;# |
| 606 | ;# Postconditions: |
| 607 | ;# none |
| 608 | ;# |
| 609 | |
| 610 | .asg “”, PIP_readprobeSET$regs |
| 611 | PIP_readprobeSET .macro dummy |

| | |
|---|---|
| 612 | .wmsg “PIP_readprobeSET not implemented for c55x” |
| 613 | .endm |
| 614 | |

| | |
|---|---|
| 615 | ; |
| 616 | ;# ======== PIP_readprobeCLR ======== |
| 617 | ; disable probing on a pipe's reader |
| 618 | ;# |
| 619 | ;# Preconditions: |
| 620 | ;# |
| 621 | ;# Postconditions: |
| 622 | ;# none |
| 623 | ;# |
| 624 | |

| | |
|---|---|
| 625 | asg “”, PIP_readprobeCLR$regs |

| | |
|---|---|
| 626 | PIP_readprobeCLR .macro dummy |

| | |
|---|---|
| 627 | .wmsg “PIP_readprobeCLR not implemented for c55x” |
| 628 | .endm |
| 629 | |

| | |
|---|---|
| 630 | ; |
| 631 | ;# ======== PIP_writeprobeSET ======== |
| 632 | ; Attach named probe to the named pipe's writer |
| 633 | ; |
| 634 | ;# Preconditions: |
| 635 | ;# |
| 636 | ;# Postconditions: |
| 637 | ;# none |
| 638 | ;# |
| 639 | |

| | |
|---|---|
| 640 | .asg “”, PIP_writeprobeSET$regs |

| | |
|---|---|
| 641 | PIP_writeprobeSET .macro dummy |

| | |
|---|---|
| 642 | .wmsg “PIP_writeprobeSET not implemented for c55x” |
| 643 | .endm |
| 644 | |

| | |
|---|---|
| 645 | ; |
| 646 | ;# ======== PIP_writeprobeCLR ======== |
| 647 | ; disable probing on a pipe's writer |
| 648 | ;# |
| 649 | ;# Preconditions: |
| 650 | ;# |
| 651 | ;# Postconditions: |
| 652 | ;# none |
| 653 | ;# |
| 654 | |

| | |
|---|---|
| 655 | .asg “”, PIP_writeprobeCLR$regs |

| | |
|---|---|
| 656 | PIP_writeprobeCLR .macro dummy |

| | |
|---|---|
| 657 | .wmsg “PIP_writeprobeCLR not implemented for c55x” |
| 658 | .endm |

| | | |
|---|---|---|
| 659 | .endif | ; if PIP_is not defined |

What is claimed is:

1. A method for creating a data structure in assembly language that conforms to the semantics of an analogous data structure in a high level language wherein the method transparently adapts the data structure to a selected set of memory alignment constraints, the method comprising the steps of:
defining a set of primitive data types that have a one-to-one correspondence to analogous primitive data types in the high level language such that the definition of each primitive data type is transparently adapted to the selected set of memory alignment constraints;
defining a template for the data structure wherein each element of the data structure is either selected from the set of primitive data types or is a substructure that is transparently adapted to the selected set of memory alignment constraints and the data structure length is transparently adapted to the selected set of memory alignment constraints;
allocating memory for the data structure based on the template definition such that the allocated memory transparently conforms to the selected set of memory alignment constraints; and
creating an initialization record for the data structure that is transparently adapted to the selected set of memory alignment constraints.

2. The method of claim 1 wherein the selected set of memory alignment constraints is determined by a memory model selected from a set of memory models supported by a compiler of the high level language, a memory length imposed by the compiler for each primitive data type of the set of primitive data types, and address alignment constraints imposed by the target hardware architecture and the compiler.

3. The method of claim 2 wherein the set of memory models is comprised of a large memory model and a small memory model.

4. The method of claim 2 wherein the step of defining a set of primitive data types is comprised of selecting a memory length and a memory alignment constraint for each primitive data type in the set of primitive data types as required by the memory model selected from the set of memory models.

5. The method of claim 4 wherein the set of primitive data types is comprised of a code pointer and a data pointer.

6. The method of claim 2 wherein the step of defining a template comprises defining a first alignment flag uniquely associated with the template such that the value of the first alignment flag indicated whether or not the data structure has a memory alignment constraint.

7. The method of claim 6 wherein the step of defining a template further comprises adjusting the length of the template in response to the memory alignment constraint indicated by the first alignment flag wherein the length adjustment comprises inserting a hole at the end of the template.

8. The method of claim 7 wherein the step of defining a template further comprises adjusting the length of the template and aligning a substructure of the data structure in response to a second alignment flag uniquely associated with a template of the substructure wherein the length adjustment and memory alignment comprise inserting a hole in the template immediately preceding the beginning of the substructure.

9. The method of claim 6 wherein the step of allocating memory is comprised of allocating memory space for the data structure at a memory alignment responsive to the memory alignment constraint indicated by the first alignment flag.

10. The method of claim 6 wherein the step of creating an initialization record further comprises transparently detecting holes inserted in the data structure to conform to the selected set of memory alignment constraints and supplying a predetermined fill value for the holes.

11. The method of claim 10 wherein the initialization record is comprised of a header and an initial value for each element of the data structure.

12. The method of claim 11 wherein the step of creating an initialization record is comprised of:
allocating space in an initialization memory for the header of the initialization record;
ensuring that a first initial value of the initialization record is placed in the initialization memory at a memory alignment responsive to the memory alignment constraints indicated by the first alignment flag;
allocating a portion of the initialization memory for each element of the data structure such that
if the element is selected from the set of primitive data types, the portion of the initialization memory allocated corresponds to the memory length of the selected primitive data type and the allocated memory space begins at a memory alignment responsive to the selected set of memory alignment constraints, or
if the element is a substructure, the portion of the initialization memory allocated corresponds to a length of a template of the substructure and the allocated memory space begins at a memory alignment responsive to a memory alignment constraint indicated by a second alignment flag uniquely associated with the template of the substructure; and
placing an initial value for each element of the data structure in the portion of the initialization memory spaced allocated to the element.

13. The method of claim 1 wherein the high level language is selected from the group consisting of C, C++, and Java.

14. A method for creating a data structure in assembly language that conforms to the semantics of an analogous data structure in a high level language wherein the method transparently adapts the data structure to a selected set of memory alignment constraints determined by a memory model selected from a set of memory models supported by a compiler of the high level language, a memory length imposed by the compiler for each primitive data type of the set of primitive data types, and address alignment constraints imposed by the target hardware architecture and the compiler, the method comprising the steps of:
defining a set of primitive data types that have a one-to-one correspondence to analogous primitive data types in the high level language by selecting a memory length for each primitive data type in the set of primitive data types as required by a memory model selected from the set of memory models;
defining a template for the data structure, wherein
a first alignment flag is created and uniquely associated with the template such that the value of the first alignment flag indicates whether or not the data structure has a memory alignment constraint;
each element of the data structure is either selected from the set of primitive data types or is a substructure;
a length of the template is adjusted in response to the memory alignment constraint indicated by the first alignment flag wherein the length adjustment comprises inserting a hole at the end of the template; and
the length of the template is adjusted and a substructure of the data structure is aligned in response to a second alignment flag uniquely associated with a template of the substructure wherein the length adjustment and substructure alignment comprise inserting a hole in the template immediately preceding the beginning of the substructure;
allocating memory for the data structure at a memory alignment responsive to the memory alignment constraint indicated by the first alignment flag; and
creating an initialization record for the data structure that is transparently adapted to the memory alignment constraint indicated by the first alignment flag and any holes inserted in the data structure to conform to the selected set of memory alignment constraints are given a predetermined fill value.

15. The method of claim 14 wherein the initialization record is comprised of a header and an initial value for each element of the data structure and the step of creating an initialization record is comprised of:
allocating space in an initialization memory for the header of the initialization record;
ensuring that a first initial value of the initialization record is placed in the initialization memory at a memory alignment responsive to the memory alignment constraint indicated by the first alignment flag;
allocating a portion of the initialization memory for each element of the data structure such that:
if the element is selected from the set of primitive data types, the portion of the initialization memory allocated corresponds to the memory length of the selected primitive data type and the allocated memory space begins at a memory alignment responsive to the selected set of memory alignment constraints, or
if the element is a substructure, the portion of the initialization memory allocated corresponds to a length of a template of the substructure and the allocated memory space begins at a memory alignment responsive to a memory alignment constraint indicated by a second alignment flag uniquely associated with the template of the substructure; and
placing an initial value for each element of the data structure in the portion of the initialization memory allocated to the element.
